(19) United States
(12) Patent Application Publication
(10) Pub. No.: US 2009/0065138 A1
(43) Pub. Date: Mar. 12, 2009

(54) Manufacture of environmentally safe cards

(75) Inventors: David Engel, Toronto (CA); William J. Garland, Mississauga (CA)

Correspondence Address: CARR & FERRELL LLP, 2200 GENG ROAD, PALO ALTO, CA, 94303, US

(73) Assignee: Innovative Graphics, Inc.

(21) Appl. No.: 12/291,099

(22) Filed: Nov. 5, 2008

Related U.S. Application Data
(63) Continuation-in-part of application No. 12/074,552, filed on Mar. 3, 2008.
(60) Provisional application No. 60/928,820, filed on May 11, 2007.

(51) Int. Cl. B32B 37/12; B65C 11/02

(52) U.S. Cl. 156/273.3; 156/60; 156/384

(57) ABSTRACT

Methods and systems for manufacturing environmentally-safe cardstock for cards are provided. An environmentally safe core material may be printed with content using environmentally safe ink. Further, a layer of environmentally safe laminate material and annotation material may be applied to the core material. The layer is adhered to the core material by activating an environmentally safe adhesive associated with the laminate material through application of pressure without requiring application of heat.

### CROSS-REFERENCE TO RELATED APPLICATIONS

The present patent application is a continuation-in-part and claims the priority benefit of U.S. patent application Ser. No. 12/074,552 filed Mar. 3, 2008, which in turn claims the priority benefit of U.S. provisional patent application No. 60/928,820 filed May 11, 2007, the disclosures of the aforementioned applications being incorporated herein by reference.

### BACKGROUND

1. Technical Field

The present invention relates generally to cards, and more particularly, to the fabrication of cards from environmentally friendly materials.

2. Description of Related Art

A wide variety of cards, cardstock, and card products are manufactured using petrochemically-derived materials, many of which may be toxic to humans and/or harmful to the environment. Examples of such cards include credit cards, debit cards, loyalty cards, gift cards, telephone cards, prepaid purchase cards, cellular communications cards, membership cards, student cards, identification cards and transit cards. These cards may contain petrochemically-derived materials such as polyvinyl chloride (PVC), polystyrene, polyester, polypropylene, polyolefins, polyethylene, polycarbonate, dioxins, polychlorinated biphenyl (PCB), and pthalates. Although some cards include a paper core, common manufacturing requires that the paper core be associated with a protective polymer coating, which is generally a petrochemically-derived polymer.

The synthesis of petrochemically-derived polymers often entails substantial harm to the environment as toxic chemicals are typically released. Further, after the cards are disposed of, the petrochemically-derived polymers in the cards degrade very slowly. As such polymers degrade, they may also release their toxic components into the environment.

Presently available methods for card manufacture include using petrochemical-based plastics and adhesives that are activated using heat. A sheet of petrochemical plastic laminate is generally applied to a sheet of petrochemical core material. Heat and/or pressure is applied to the layers, and the heat activates a dry thermal adhesive on the laminate material such that the laminate adheres to the core.

Further, the use of environmentally safe materials to manufacture cardstock has been proven to be difficult and complicated. For example, various environmentally safe adhesives may ooze in an unsightly fashion when heat and/or pressure is applied. Further, environmentally safe inks may require more time to dry than petrochemical-based inks. Methods of drying that involve drying powders may result in unevenness, unsightly blemishes, and other unwanted inconsistencies in the print. Still further, laying down a magnetic strip on a card in an environmentally safe fashion may require much more pressure than conventional materials and methods using petrochemical-based adhesives. The additional pressure may result in unsightly cracks, fractures, and breaks in the magnetic stripe. Laying down a magnetic strip on environmentally safe materials may further require special adhesive formulations.

Environmentally safe, for the purposes of this application, is used to describe degradable materials. Such degradable materials further include environmentally safe materials. Specifically, environmentally safe materials may degrade (or biodegrade) into renewable, organic, non-toxic, and/or inert components. The replacement of the petrochemically-derived polymers with environmentally safe materials made of, for example, renewable polymers or inert polymers may decrease the environmental impact of cards, cardstock, and card products.

There is, therefore, a need for improved systems and methods for manufacturing environmentally safe cardstock for cards.

### SUMMARY OF THE INVENTION

Embodiments of the present invention provide for methods and systems for manufacturing environmentally-safe cardstock for cards. Content may be printed on a sheet of environmentally safe core material. The printing involves the use of environmentally safe inks. Further, a layer of an environmentally safe laminate material and/or annotation material is applied to the core material. The laminate layer is adhered to the core material by activating an adhesive associated with the laminate material through application of pressure without requiring the application of heat.

Various embodiments of the present invention may include methods for manufacturing environmentally-safe cardstock for cards. Such methods may include applying a layer comprising an environmentally safe laminate material onto a sheet of environmentally safe core material and activating an environmentally safe adhesive associated with the laminate material through application of pressure, so that the laminate material adheres to the sheet of core material, with or without the application of heat. In some embodiments, the adhesive may further be food grade.

Embodiments of the present invention may further include systems for manufacturing environmentally-safe cardstock for cards. Such system may include a sheet including an environmentally safe laminate material associated with an environmentally safe adhesive and a liner material associated with an adhesive side of the laminate material. In some embodiments, the sheet of laminate material/liner is flexible and provided as a continuous sheet from a roll. Systems may further include a laminator (e.g., laminating machine, laminating station, or laminating device) configured to activate the adhesive associated with the laminate material through application of pressure, wherein the laminate material adheres to an environmentally safe core material with or without the application of heat.

In further embodiments of the present invention, methods may include printing content on a sheet of environmentally safe core material using an environmentally safe ink, drying the ink through exposure to ultra-violet (UV) light, and then applying an environmentally safe laminate material and an annotation material to the printed sheet of core material, the annotation material being configured to retain information for electronic access to data associated with a card. Configuration for retaining information may include magnetic striping, bar codes, and/or embedded computer chip technology.

In still further embodiments of the present invention, methods for manufacturing environmentally safe cardstock for cards may further include applying an annotation material to a portion of an environmentally safe laminate material, the annotation material being configured to retain information for electronic access to data associated with a card, activating an environmentally safe adhesive associated with the laminate material through application of pressure so that the annotation material adheres to the laminate material without requiring application of heat, and applying a layer comprising the laminate material and the annotation material onto a sheet of environmentally safe core material.

### BRIEF DESCRIPTION OF THE DRAWINGS

FIG. 1A is a schematic of a core layer, according to various embodiments.

FIG. 1B is a schematic of a core layer with an annotation material, according to various embodiments.

FIG. 1C is a schematic of a core layer, annotation material, and protective layer, according to various embodiments.

FIG. 2A is a schematic of a first embodiment of an information card.

FIG. 2B is a schematic of a second embodiment of an information card.

FIG. 2C is a schematic of a third embodiment of an information card.

FIG. 2D is a schematic of a fourth embodiment of an information card.

FIG. 2E is a schematic of a fifth embodiment of an information card.

FIG. 3 is a schematic of an exemplary architecture for use of an information card.

FIG. 4 is a flowchart illustrating a method for manufacturing environmentally safe cards, according to various embodiments.

### DETAILED DESCRIPTION

Various embodiments of the present invention provide for methods and systems for manufacturing environmentally-safe cardstock for cards. Content may be printed on a sheet of environmentally safe core material. The printing involves the use environmentally safe ink. Further, a layer including an environmentally safe laminate material and/or an annotation material may be provided as a rigid sheet or as a flexible sheet from a roll. The layer of laminate/annotation material is applied to the core material. The laminate/annotation layer is adhered to the core material by activating an environmentally safe adhesive associated with the laminate material through application of pressure and without requiring application of heat.

For the purposes of this application, a card, or card product, refers to product fabricated from cardstock. Cardstock refers to a substantially planar sheet of material that is much thinner (e.g. by a factor of 10, 100, 1000, or greater) than it is long and wide, such that it can be used for the fabrication of cards, boxes, packaging, envelopes, or similar objects. Common thicknesses of cardstock range from 1 to 100 points (or mils) thick. Thicknesses in the range of 24-32 points are most common for certain card products, such as credit cards, gift cards, loyalty cards, identify cards, communications cards, etc. Various thicknesses of laminate can be used for a variety of different card applications—for 0.5/1000″, 2/1000″, 5/1000″, 8/1000″, 10/1000″, 12.5/1000″, 15/1000″, 20/1000″, 24/1000″ 30/1000″, 40/1000″, 50/1000″ or any other thickness required to meet an application need.

In general, a primary difference between cardstock and a card is lateral dimension. Cards are generally characterized by lengths and widths having similar magnitudes (e.g., 3 inches by 5 inches for a “3×5 card” or 3.375 inches by 2.125 inches for a standard ISO 7810 card), and these magnitudes are typically of the order of a few inches in each dimension. Cardstock is typically long and wide enough that automated machinery can efficiently manufacture large quantities of cards or card products from a single piece of cardstock. Cardstock widths may be several inches, a few feet, or even tens of feet, and lengths may be several inches, a few feet, tens of feet, or even hundreds of feet. During manufacture of card products, cardstock is often cut or die cut into cards, which are typically small enough in size to meet industry standard specifications for various business applications and to allow for convenient handling by the user. Thus a gift card card may have lateral dimensions of approximately 3.375 inches×2.125 inches, but be fabricated from cardstock that is several feet in width and (in some cases) hundreds of feet in length. Cardstock may often be processed in a manner that creates many card products (other than cards) from a single piece of cardstock that is subsequently cut to form discrete card products.

As mentioned above, environmentally safe, for the purposes of this application, is used to describe degradable, and especially biodegradable, materials. Further, these environmentally safe materials degrade into renewable, organic, non-toxic, and/or inert components. Examples of such components include renewable polymers, which come from materials that are readily replaceable by new growth. These materials include vegetable-based feedstocks such as corn, sugar cane, or other crops. In some embodiments, renewable polymers may include polymers derived from waste products. Examples of renewable polymers include polylactide (PLA), polyhydroxyalkanoate (PHA), and polyhydroxybutyrate (PHB). An inert polymer is a polymer derived from materials that are not significantly reactive with other materials. Examples of inert polymers may include polyester polymers, high impact polystyrene, Pro-Print®), Synthetic Paper, Transalloy® P-300 Multi-Polymer Alloy, Transalloy® P-260EX Multi-Polymer Alloy, etc. Inert polymers, as referred to in this application, may include polymers that degrade into inert materials. Some polymers may be both renewable and inert.

In some embodiments, a polymer may require a short period of time to degrade naturally (e.g., PLA is degradable within sixty days under ideal conditions). Biodegradation may, for example, include decomposition caused by a photodegradable process, microorganisms, through exposure to water, or a combination of these. This may be due to the polymer being derived from a vegetable-based or other organic material.

For the purposes of this application, an information card is a substantially planar card product, having dimensions of a few inches or less in length and width, that includes an annotation region configured to retain information for electronically accessing data associated with the information card. An information card incorporates information that can be conveyed to a user of the card. An information card can also incorporate information from a user (e.g., a user's signature). In general, an information card may be fabricated from cardstock, and a material that can be fabricated into an information card may be considered cardstock. These latter applications are categorized as “card products.”

Cards such as credit cards, debit cards, loyalty cards, gift cards, telephone cards, cellular communications cards, prepaid purchase cards, membership cards, student cards, identification cards, and transit cards are exemplary types of information cards. Information cards may also include marketing and/or advertising information.

For convenience, various aspects are described in the context of a single information card, although these aspects are equally applicable to cardstock and card products that convey information.

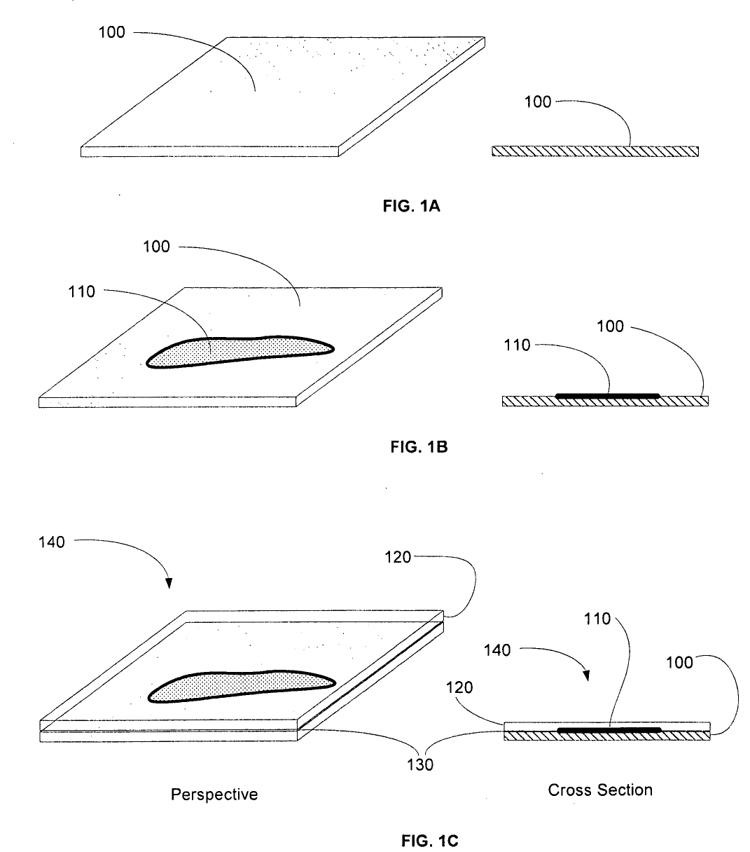

FIG. 1A is a schematic of a core layer 100 according to various embodiments. Core layer 100 is an environmentally safe material having a thickness substantially smaller than its length and width. In general, the thickness of the core layer 100 will be determined by the application toward which a card is directed, but common thicknesses may range from 10 to 100 points (or mils or thousandths of an inch) thick. Many common card applications demand thicknesses in the range of 10 points to 35 points. Core layer 100 may be based on PLA, PHA, PHB, or any number of other renewable and/or inert materials. In some embodiments, the core layer 100 may be made of paper. The core layer 100 provides the core layer in a card.

FIG. 1B is a schematic of a core layer 100 with an annotation region 110 according to various embodiments. The annotation region 110, or annotation material 110, is configured to retain information for electronically accessing data associated with the information card. For the purposes of this specification, the general process of adding information to a core layer 100 is referred to as annotation, and doing so generates the annotation material 110. Whether annotated information is attached as a separate entity, printed, embossed, or otherwise added to core layer 100, the annotation material 110 conveys the annotated information.

Annotation material 110 conveys data, which may appear as embossed, etched, scored, cut, dyed, bleached, engraved, or otherwise provided on an information card. Data provided by annotation material 110 may also appear as printed, screened, painted, sublimated, written, or deposited on the information card. For information annotated via deposition or printing, the use of inks or paints based on environmentally safe materials, particularly vegetable-based inks, may be desirable. Information may be printed on the core layer 100 using thermal printing, dye sublimation printing, ink jet printing, laser printing, and magnetography printing, flexographic printing, and offset printing. Those skilled in the art will appreciate that there are many ways to provide annotation material 110.

Annotation material 110 may also include a discrete, information-carrying component, such as a magnetic strip including a magnetizable material, whose magnetization pattern carries information. Such a magnetic strip may be manufactured from raw film and then magnetized to encode information. Annotation material 110 may also include random access memory (RAM), read only memory (ROM), flash memory, programmable-ROM, ferroic memory, or any other computer readable media that can carry information. In some embodiments, providing the annotated material 110 may include generating an electronically readable “smart card.” An annotation material 110 may include a radio-frequency identification (RFID) chipset or an “electronic ink” material, as will be apparent to those skilled in the art.

The annotation material 110 may also convey data via an image, a pattern, a shape, a logo, a barcode, a two-dimensional barcode and/or text. The annotation material 110 may also provide a particular surface finish, a roughness, a tactile “feel,” a specific elastic response, a reflectivity or any other physical parameter that may be incorporated in a fashion such that its value is associated with a particular person or entity.

In various embodiments, information may be annotated onto the annotation material 110 in a fashion that enhances the efficient fabrication of products from cardstock. For example, a large number of annotation material 110 (e.g., printed logos or text blocks) may be provided on cardstock in a regular pattern, such that the cardstock can subsequently be cut into discrete units, each having a core layer 100 that has identical information printed thereon. As is known to those skilled in the art, a similar pattern can also be used to annotate distinct information onto each annotation material 110 (such as a unique barcode or smart chip) such that the subsequent cutting of the cardstock results in core layers 100 having different presentations of data provided by the annotation material 110.

Additional features can also be included as part of an information card. For example, a lenticular lens or fresnel lens may be incorporated into annotation material 110 during fabrication, and in some cases the lens may be fabricated from the material used for core layer 100. The annotation material 110 may also include a reflective (e.g., metal foil) layer or holographic layer, a security feature, or an anti-tampering device.

FIG. 1C is a schematic of a core layer, annotation material, and protective layer according to various embodiments. Information card 140 includes core layer 100, annotation material 110, and protective layer 120. Because degradation can corrupt the information conveyed by the annotation material 110 (e.g., rendering printed text unreadable), an information card 140 may include the protective layer 120 to prevent degradation. Protective layer 120 is attached to core layer 100, and in exemplary information card 140, these layers are adhered to each other using adhesive 130.

Protective layer 120 may be an environmentally safe material that is sealingly affixed to core layer 100 and annotation region 110. Protective layer 120 prevents degradation of the information conveyed by the annotation region 110 for a limited duration. For optically recognizable information (such as printing), the protective layer 120 may be transparent, an example of which is transparent PLA. For information that can be transmitted through opaque materials (e.g., if annotation material 110 is provided as a magnetic strip), the protective layer 120 may be opaque. For a component of annotation material 110 that requires physical contact to the outside world (e.g., electronic pins in a smart card) the protective layer 120 may have appropriate gaps or access points. Protective layer 120 may be of similar dimensions to core layer 100 and be provided as a laminate over the core layer 100.

The protective layer 120 may be affixed to core layer 100 using a method that does not require an additional adhesive material (e.g., by diffusion bonding or thermal welding). Optionally, protective layer 120 may be affixed to core layer 100 using an adhesive, which is shown in FIG. IC as adhesive 130, at the interface between core layer 100 and protective layer 120. The thickness and opacity of adhesive 130 are such that any transparency requirements of the combination of protective layer 120 and adhesive 130 are fulfilled. In some aspects, a solvent-free adhesive may be used, and in several aspects, an adhesive with minimal (or even no) solids loading may be used.

An example arrangement of the core layer 100, annotation material 110, and protective layer 120 is shown in FIG. IC as information card 140. However, many other arrangements are within the scope of the invention.

In general, many information cards will be fabricated according to industry-standard specifications that are particular to the type of information card being fabricated. Exemplary standards include the CR80 “credit card” format (approximately 3.375″ by 2.125″ by 0.2 points to 0.3 points thickness and the CR50 “luggage tag” format (approximately 3.5″ by 2.09375″ by 0.20 points thickness. A compact disc case may include an information card approximately 4 inches square, and a direct mailing insert may include an information card of dimensions 8.5 by 11 inches. However, the present invention is not limited to a particular (or even any) industry standard dimension, nor is it limited to a particular method of information annotation.

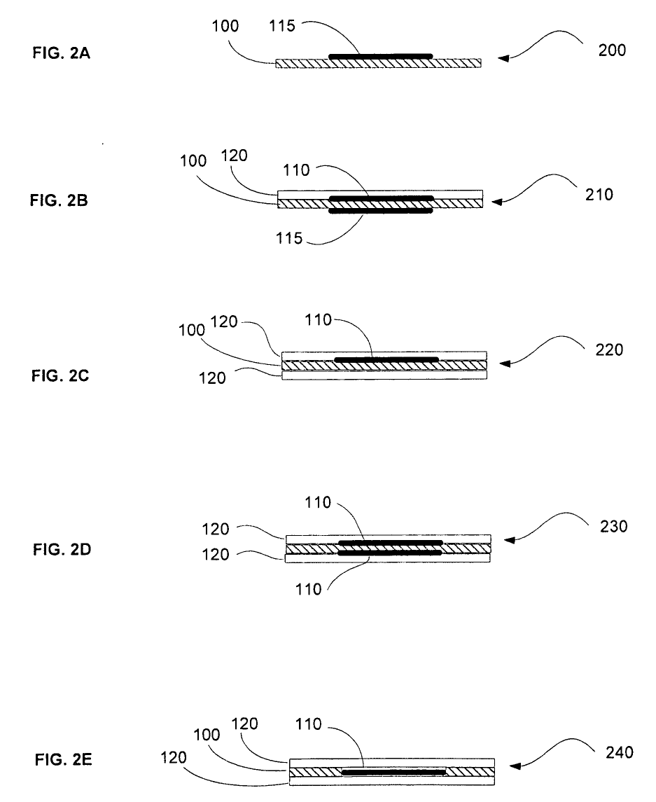

FIGS. 2A-2E are schematics showing examples of different arrangements of components in an information card. In each of these examples, adhesive may or may not be used and is omitted for clarity. These examples are for illustrative purposes only and are not intended to be limiting.

FIG. 2A is a schematic of a first embodiment of an information card 200. Information card 200 includes an annotation region 115 that does not require additional protection, such as an embossed logo, an etched bar code, or a smart card affixed to the core layer.

FIG. 2B is a schematic of a second embodiment of an information card 210. Information card 210 includes both an annotation region 110 beneath protective layer 120 and another annotation region 115 on the opposite side of core layer 100. Information card 210 could be a card having protected text on one side and an unprotected magnetic strip on the other side. For an information card 210 in which a user writes on an annotation region, it may be advantageous to include a writable surface as part of annotation region 115. Exemplary writing surfaces include a hot foil writable patch, a printed writeable coating, or even a label.

FIG. 2C is a schematic of a third embodiment of an information card 220. Information card 220 includes annotation region 110 and core layer 100 between two protective layers 120. Information card 220 may provide protection of core layer 100 by the protective layers 120, even on a side where core layer 100 does not carry information. The mechanical properties of information card 220 may be enhanced by choosing protective layers 120 made of a different material than that of core layer 100. Typical thicknesses of an exemplary information card 220 having printed annotation region 110 include seven-point protective layers 120 on both sides of a twelve-point core layer 100, or ten-point protective layers 120 on both sides of a ten-point core layer 100.

The configuration of information card 220 may also be used to annotate a particularly thin core layer 100 (e.g., less than 10 mils thick) via an annotation method that requires the thin core layer (e.g., newsprint methods). The card can then be thickened, stiffened or made stronger by incorporating protective layers 120 (e.g., having thicknesses of ten mils or more) as shown.

FIG. 2D is a schematic of a fourth embodiment of an information card 230. Information card 230 shows an embodiment in which information is conveyed on both sides of the card via two annotation regions 110. The information card 230 additionally includes two protective layers 120 sealingly affixed to the two annotation regions 110.

FIG. 2E is a schematic of various embodiments of an information card 240. Information card 240 includes an area in core layer 100 such that annotation region 110 provides for a transparent region in the information card 240. Annotation region 110 may also comprise a lens in this configuration.

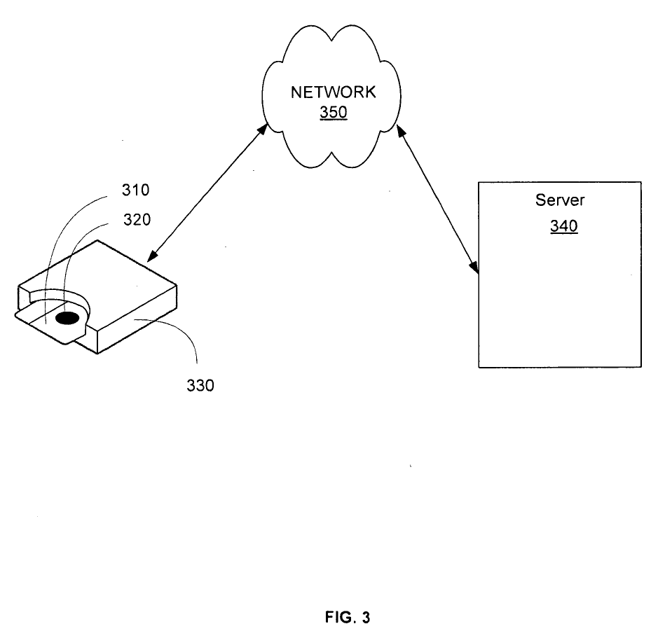

FIG. 3 is a schematic of an exemplary architecture for use of an information card. Information card 310 includes annotation region 320, which may be a printed bar code, an identification number, a magnetic strip, a smart chip, or any other type of information that provides for the interaction of information card 310 with an appropriate card reader 330. Card reader 330 is an apparatus appropriately matched to the type of information card 310 and annotation region 320. For example, card reader 330 may be a bar code reader or other optical device if annotation region 320 includes a bar code. Alternatively, card reader 330 may be a magnetic strip reader or a device to access information from a smart card. Card reader 330 typically includes sufficient processing, memory, sensing, and communications hardware necessary to access information from information card 310, convert the information to digital form and transmit the information electronically. Transmission may include the use of the Internet Protocol. Card reader 330 may also include a display device to display information to the user, and may also include appropriate hardware to process a financial transaction based on information in annotation region 320. Although card reader 330 is schematically shown as a compact device substantially enclosing information card 310, card reader 330 may have a different geometric configuration, such as a hand held optical scanner. If annotation region 320 includes an RFID chip, card reader 330 may be an appropriate reading apparatus disposed at a substantial distance (e.g., 1 foot, 3 feet or even 10 feet) from information card 310.

Card reader 330 reads information from and may also write information to annotation region 320. In other aspects, card reader 330 may transmit the information to server 340 over network 350. Network 350 may include a local area network (LAN), wide area network (WAN), or the like. Server 340 includes a processor, memory, storage device, network hardware, input/output hardware, along with appropriate software. Server 340 also includes a computer readable storage medium, having embodied thereon a program, the program operable by a processor to perform a method comprising electronically accessing data associated with the information card 310. Server 340 may include account information related to information card 310, as is typical for information cards such as credit cards, loyalty cards, transit cards, and the like.

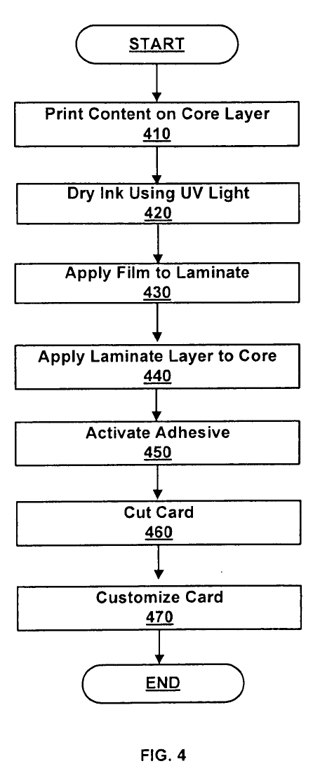

FIG. 4 is a flowchart illustrating a method for manufacturing environmentally safe cards, according to various embodiments. In this method, content is printed on a core layer. The ink from the printing is dried. An annotation material is applied to at least a portion of a sheet of laminate material, and the layer formed of the annotation material and the laminate material is applied to the printed core. An adhesive associated with the laminate material may then be activated to adhere the laminate layer to the core. The result is a sheet of cardstock from which one or more cards may be cut. The various components, including the core, ink, laminate, annotation material, and adhesive are preferably all environmentally safe. In various embodiments of the present application, the order of the steps may be rearranged.

In step 410, content is printed on a core layer. Specifically, a core layer made of an environmentally safe material may printed with content, which may include text, graphics, designs, etc. Such content may be provided based on various user specifications. The printing is performed using environmentally safe inks, which may include various vegetable-based and/or organic inks. Such inks may further be food grade.

In step 420, the environmentally safe ink is dried. Various ways of drying the inks may include air drying, hot air drying, radiant heat drying from an electric of gas-fired dryers, and ambient air drying on drying racks/tables. Certain formulations of environmentally safe inks may also dry more quickly when exposed to ultra-violet light. Various lamps, light bulbs, and light sources may provide such ultra-violet light.

In step 430, an annotation material is applied to a sheet of environmentally safe laminate material. The annotation material is non-toxic and may or may not be environmentally safe. In some embodiments, data is conveyed by magnetizing the annotation material to encode such data. Other embodiments may include encoding data through use of magnetic ink, computer chips, and the like Various embodiments further provide that the annotation material be applied to at least a portion of the laminate material and that an environmentally safe adhesive associated with the laminate and/or annotation material be activated through application of pressure with or without the application of heat. The activated adhesive allows the annotation material to adhere to the laminate material. The laminate material serves as a protective layer, such as protective layer 120, and is laminated to the core. In some embodiments, the laminate material may be provided as a rigid sheet. Further embodiments provide that the laminate material be flexible enough to be provided in rolls. Further embodiments allow for the resulting layer of material including both the annotation material and the laminate to be provided in sheets or rolls. In some embodiments, the sheets or rolls may further include a liner associated with an adhesive side of the laminate material and/or an adhesive side of the annotation material.

In step 440, the layer including both the annotation material and the laminate material is applied to the core layer. In some embodiments, the core may be provided in sheets and a sheet of the laminate layer may be applied to a surface of the core layer. Further embodiments provide for flexibility of the laminate material, which allows for the laminate material to be fabricated in a continuous roll. Such a roll allows for a sheet of the layer to be rolled onto the surface of the core.

In some embodiments, such a layer may provide structural strength, a preferred elastic response, shape constraint, flatness constraint or other properties of the protective layer. Thus, step 440 may be repeated for the opposite surface of the core, such that the core is sandwiched between two protective layers. In an exemplary embodiment, one side of the core may be adhered to a layer including both an annotation material and laminate material. The other side of the core, however, may be adhered to the laminate material without any annotation material.

In step 450, an environmentally safe adhesive associated with the laminate material is activated based on application of pressure without requiring application of heat. The activated adhesive allows the layer including both the annotation material and the laminate to adhere to the core. Activation of adhesives, such as that described with respect to steps 430 or 450, may be performed using application of pressure with or without application of heat. The adhesive used is a pressure-sensitive adhesive, not a thermal adhesive. Thermal adhesives are often characterized by a bonding temperature, which may be a temperature above which the adhesive must be heated before its bonding properties are activated. The adhesive activation in steps 430 or 450 do not require the application of heat. The amount of pressure required may be determined based on the various physical properties of the materials being adhered together, including the properties of the core, laminate, and optionally the annotation material. While the application of pressure may result in generation of heat, such generation is incidental and is not required to activate the adhesive.

In step 460, the resulting cardstock formed according to steps 410-450 may be cut into cards. Various available methods may be used with respect to cutting and further processing the cardstock to form one or more cards.

In step 470, a card may be further customized and/or personalized. Such customization/personalization may be provided through encoding, printing, etching, embossing, and/or special laminations, including decals, labels, and holograms.

Because the cards are degradable (or biodegradable) into renewable, organic, non-toxic, and/or inert materials, the cards may be considered environmentally safe. When such cards are discarded and disposed, therefore, the environmentally safe materials break down into residual components that are non-toxic and safe for the environment.

The above description is illustrative and not restrictive. Many variations of the invention will become apparent to those of skill in the art upon review of this disclosure. The scope of the invention should, therefore, be determined not with reference to the above description, but instead should be determined with reference to the appended claims along with their full scope of equivalents.

What is claimed is:

1. A method for manufacturing environmentally safe cardstock for cards, the method comprising:
applying a layer comprising an environmentally safe laminate material onto a sheet of environmentally safe core material; and
activating an environmentally safe adhesive associated with the laminate material through application of pressure, wherein the laminate material adheres to the sheet of core material without requiring application of heat.

2. The method of claim 1, further comprising generating the layer by applying an annotation material to at least a portion of the laminate material, the annotation material being configured to retain information for electronic access to data associated with a card.

3. The method of claim 2, wherein applying the annotation material to the portion of the laminate material includes activating the environmentally safe adhesive associated with the laminate material through application of pressure and wherein the raw film adheres to the laminate material without requiring application of heat.

4. The method of claim 1, further comprising printing content onto the sheet of core material using environmentally safe ink and drying the ink through exposure to ultra- violet light.

5. The method of claim 4, wherein the ink is vegetable-based.

6. The method of claim 1, wherein the laminate material is flexible and provided from a roll.

7. The method of claim 1, wherein the adhesive is food-grade.

8. A system for manufacturing environmentally safe cardstock for cards, the system comprising:
a roll comprising an environmentally safe laminate material, wherein a portion of the laminate material is associated with an environmentally safe adhesive, and a liner material associated with the adhesive portion of the laminate material; and
a laminator configured to activate the adhesive associated with the laminate material provided by the roll through application of pressure, wherein the laminate material adheres to an environmentally safe core material without requiring application of heat.

9. The system of claim 8, further comprising a printer configured to print on material using environmentally safe ink.

10. The system of claim 9, further comprising an ultra-violet light configured to dry the environmentally safe ink.

11. The system of claim 9, wherein the ink is vegetable-based.

12. The system of claim 8, wherein the roll of laminate material further comprises an annotation material, the annotation material having been applied to at least a portion of the laminate material and the annotation material being configured to retain information for electronic access to data associated with a card.

13. The system of claim 12, wherein the annotation material is applied by activating the environmentally safe adhesive associated with the laminate material through application of pressure and wherein the annotation material adheres to the laminate material without requiring application of heat.

14. The system of claim 8, wherein the adhesive is food-grade.

15. A method for manufacturing environmentally safe cardstock for cards, the method comprising:
printing content on a sheet of environmentally safe core material using environmentally safe ink;
drying the environmentally safe ink through exposure to ultra-violet light; and
applying an environmentally safe laminate material and an annotation material to the printed sheet of core material, the annotation material being configured to retain information for electronic access to data associated with a card.

16. The method of claim 15, wherein the ink is vegetable-based.

17. A method for manufacturing environmentally safe cardstock for cards, the method comprising:
applying an annotation material to at least a portion of an environmentally safe laminate material, the annotation material being configured to retain information for electronic access to data associated with a card;
activating an environmentally safe adhesive associated with the laminate material through application of pressure, wherein the annotation material adheres to the laminate material without requiring application of heat; and
applying a layer comprising the laminate material and the adhered annotation material onto a sheet of environmentally safe core material.

18. The method of claim 17, wherein the laminate material is flexible and provided from a roll of laminate material.

19. The method of claim 17, wherein the adhesive is food-grade.

20. The method of claim 17, wherein the layer comprising the laminate material and the adhered annotation material is applied by activating the environmentally safe adhesive associated with the laminate material through application of pressure and wherein the core material adheres to the laminate material of the layer without requiring application of heat.
